(19) United States
(12) Patent Application Publication
(10) Pub. No.: US 2009/0229471 A1
(43) Pub. Date: Sep. 17, 2009

(54) Two Cups Automatic Coffee Maker with Flow Control

(76) Inventors: Man Fai Lun, Hong Kong (CN); Chi Wai Kok, Hong Kong (CN)

Correspondence Address: AKERMAN SENTERFITT, P.O. BOX 3188, WEST PALM BEACH, FL, 33402-3188, US

(21) Appl. No.: 12/049,859

(22) Filed: Mar. 17, 2008

(51) Int. Cl. A47J 31/46; A47J 31/02

(52) U.S. Cl. 99/300; 99/290

(57) ABSTRACT

The present invention relates to a coffee maker and more specifically to a two cups automatic coffee maker with flow control in a precise manner, particular to a one cup coffee in desired volume, a two reservoirs type design to avoid overfill and able to have two different tastes, with a manual reset thermostat controls to turn off the heaters while brewing cycle is completed.

### FIELD OF THE INVENTION

The present invention relates to a coffee maker and more specifically to a two cups automatic coffee maker with flow control to make a precise number of cups of coffee and with two different tastes.

### BACKGROUND OF THE INVENTION

Brewing coffee also called dripped coffee method, which is the most common coffee making method. It had been widely used at home and/or commercial such as office and hotel. Today many people use: automatic drip coffee makers to brew coffee because they can have a cup of hot coffee anytime and unlike before had to boil and wait for hot water to make coffee while they can leave and go to do something else.

Although conventional automatic drip coffee makers work well for their intended purpose, but one problem with their associated use is a typical design of convention drip type coffee maker in which a heater soldered water duct is designed to pump the water from a cold reservoir into the coffee brewing chamber, which is hardly to manage the flow control in a precise manner, particular to a one cup coffee in desired volume. The existing design is always has to pump empty the cold reservoir so that to avoid interrupting the brewing cycle. Therefore to brew only one-cup coffee the coffee maker has to build with a one-cup cold reservoir.

In order to brew two cups coffee at the same time and able to have different tastes, it is necessary to have the cold reservoir with the volume over two cups, and then to control the flow from the cold reservoir needs not to be pumped empty if only one cup coffee is to be served. Precisely flow control is also vital in considering brewing two cups coffee tandem to avoid excessive coffee slops over the cup, or not enough coffee due to the premature stoppage in the brewing cycle.

In the meanwhile the design of the conventional automatic drip coffee makers in the existing market are also not reliable in safety concern because the automatic reset thermostat employed in the circuitry cannot stop energizing the machine permanently as soon as the brew is completed. This is inherent fire hazardous especially if the thermal plastic is used for the enclosure. A manual reset thermostat control is therefore built to replace the automatic reset thermostat in order to improve the coffee maker in safety aspect.

### SUMMARY OF THE INVENTION

The present invention address the problems discussed above and aims to provide a coffee maker that has the following features: with flow control in a precise manner; particular to a one cup coffee in desired volume, two reservoirs type design to avoid overfill and able to have different tastes, a manual reset thermostat controls to turn off the heaters while brewing cycle is completed, and cancel button with pause and resume function. These features are embodied in a single construction of the coffee maker.

The two cups automatic coffee maker of the present invention comprises the following elements: the invention is to redesign the cold reservoir construction so that there are a primary reservoir and a secondary reservoir to manage the flow control precisely for the cups in desired volume particular serving two cups coffee at the same time with different tastes. Both the primary and secondary reservoirs have the volume identical to the cup with the desired volume. Each reservoir is built with a floating block, which is to provide the indication of the amount of water filled.

The user can choose both reservoirs at the same time in order to brew two cups coffee. Because of the separated basket therefore it is possible to have two different tastes at the same time, with a cancel button to serve as a “pause and resume” function so that user can be paused and resumed in the mid way of the brewing cycle in which the convention drip type coffee maker does not have this function at all.

### BRIEF DESCRIPTION OF THE DRAWINGS

FIG. 1 is the sectional view of the two cups automatic coffee maker.

FIG. 2 is the side sectional view of the two cups automatic coffee marker.

FIG. 3 is the sectional view of the sluice-valve of the two cups automatic coffee marker.

FIGS. 4a, 4b and 4c are the embodiment of the two cups automatic coffee maker for brewing two different tastes at the same time.

FIG. 5 is the structural view of the manual reset thermal control of the two cups automatic coffee maker.

### DETAILED DESCRIPTION OF THE INVENTION

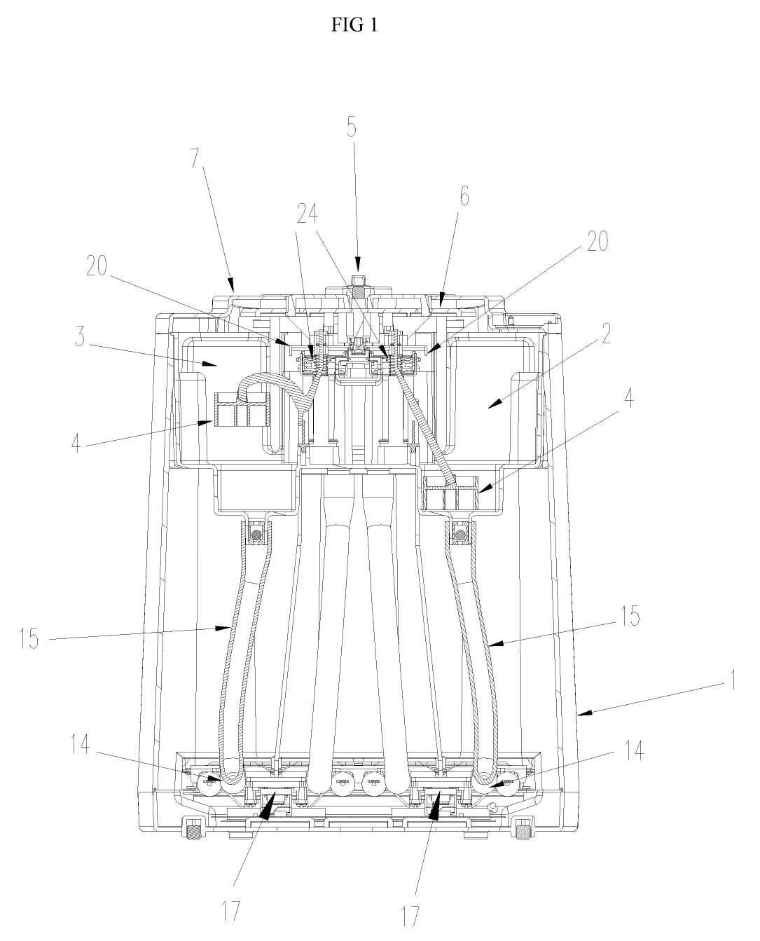

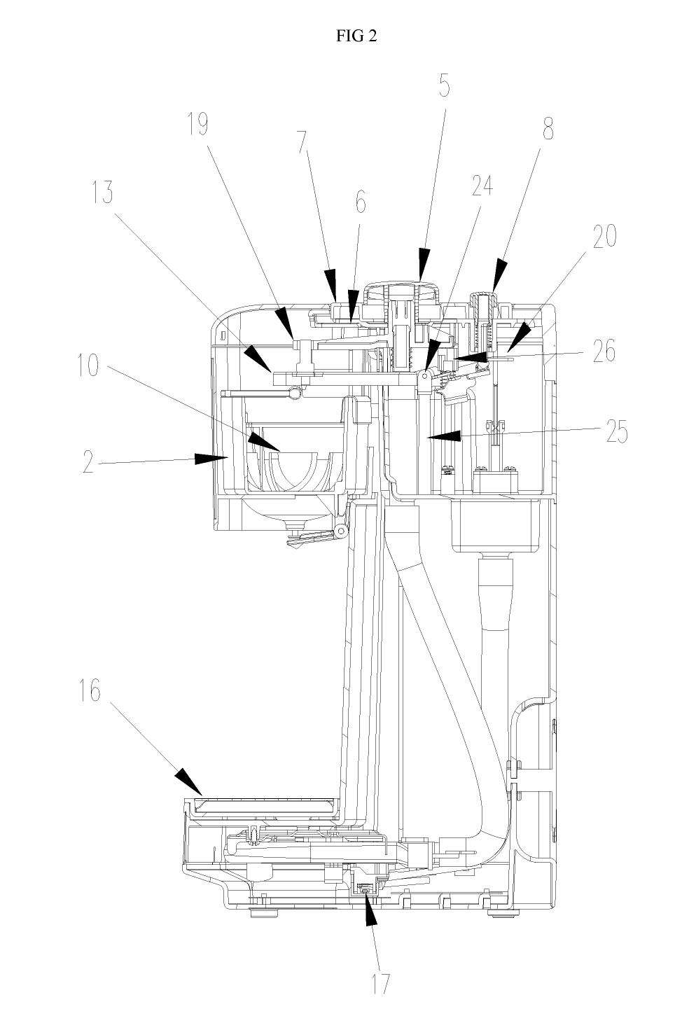

As shown in FIG. 1 and FIG. 2, the two cups automatic coffee maker with flow control it comprises: a main house 1, primary reservoir 2, secondary reservoir 3, floating block 4, main switch 5, switch mount 6, switch cover 7, cancel button 8, top cover 9, coffee filters 10, coffee filter holder 11, brewing chamber 12, sprinkle heads 13, heater soldered water ducts 14, water pipes 15, drip tray 16, manual reset thermal controls 17, bottom cover 18, pusher 19, horizontal linkage 20, disc shape bimetal 21, terminals 22, spring 23, switching mechanism 24, sluice-valve 25, adjustable screw 26.

As shown in FIG. 2 the two cups automatic coffee maker with flow control, the spring loaded main switch 5 is a kind of momentary ‘ON’ press switch, in which is designed to have the stroke length controlled not able to activate the switching mechanism 24 unless the horizontal linkage(s) 20 is/are in place. It will bounce back to its initial position if not holding the press.

There is a switching mechanism 24 in each Primary reservoir 2 and Secondary reservoir 3. This switching mechanism 24 is designed to sit on top of the reservoir and consists of a long bar hooked to the manual reset thermal control 17. When the reservoir 2 or 3 is filled with enough water and the main switch 5 is pressed it pull up the manual reset thermal control 17 to close the circuitry via this long bar.

The cancel button 8 is designed to stop the brewing cycle or to break the electric circuitry manually. This button is also spring loaded and is designed to link with the switching mechanism 24. When this button is pressed it will push open the manual reset thermal control 17 via the long bar and break the electric circuitry, thus to stop the brewing cycle.

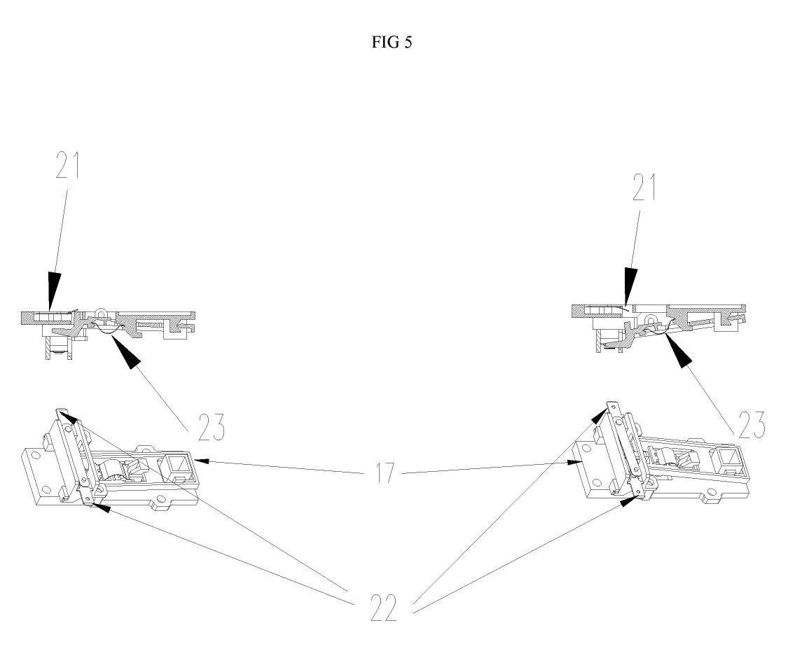

As shown in FIG. 5 the two cups automatic coffee maker with flow control, the manual reset thermal control 17, in which designed like a v-shape clothing-pinch, is consists of a disc shape bimetal 21, two terminals 22 and a spring 23, is built underneath in each Primary reservoir 2 and Secondary reservoir 3. The disc shape bimetal 21 is used to sense the temperature drift and will deform upon reaching the dry boil temperature. The two terminals 22 are wired to the circuitry and serves as the open/close function. When the manual reset thermal control 17 is at the open stage the two terminals 22 making no contact, vice versa they contact each other when the manual reset thermal control 17 is at the close position, thus form the close-loop electric circuitry. The spring 23 is designed to help the manual reset thermal control 17 stays firmly and mechanically either at the open or close position. As soon as the brewing cycle is completed and the disc shape bimetal 21 deformed after sensing the dry boiling, it triggers the spring 23 and push open the manual reset thermal control 17 so that the electric circuitry stays permanently open.

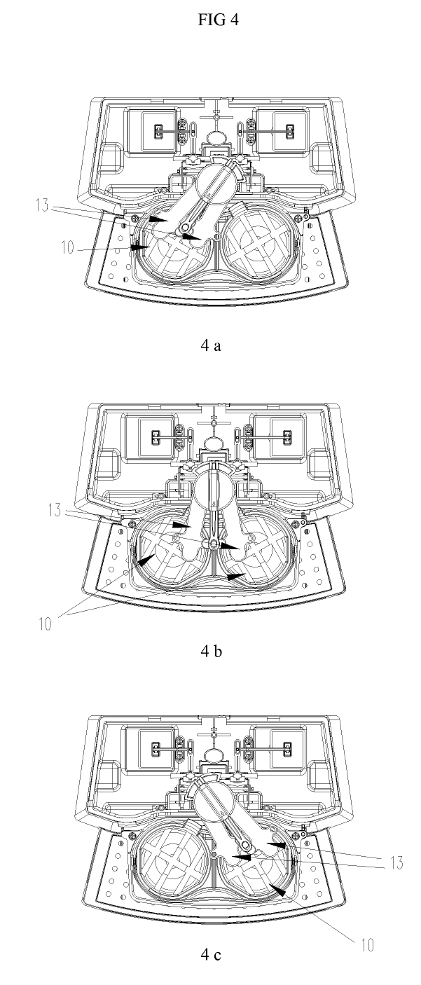

As shown in FIGS. 4a, 4b and 4c the two cups automatic coffee maker with flow control, the Primary and Secondary reservoirs 2 & 3 have their separated sprinkle head 13. The sprinkle heads 13 from both reservoirs are linked up to the main switch 5 for selecting the mug on either left/right/or both sides. When turn the main switch 5 to the left hand side for brewing only one cup coffee shown in 4a, both the sprinkle heads 13 are sitting on top of the coffee filter 10 at the left so that the hot water can be pumped from the primary reservoir 2, or the secondary reservoir 3 when the primary reservoir 2 is empty. This concept applies the same to the right hand side selection shown in 4c. When the main switch 5 stays at the middle for brewing 2 cup coffees shown in 4b, the sprinkle heads 13 are now sitting separately to the coffee filters 10 at left and right sides. With the separated coffee filter 10 design it allows the selection of 2 different tastes coffee.

In the primary reservoir 2 when there is water filled the floating block 4 will rise up and activate a horizontal linkage 20 so that it links up with the switching mechanism 24 built to this primary reservoir. When the user selects to brew one cup only and the push button is pressed with both the sprinkle heads 13 at either left or right orientation the switching mechanism 24 actives and it starts to energize the heater soldered water duct 14 underneath the primary reservoir 2. When the primary reservoir 2 pumps empty then the manual reset thermal control 17 will break the circuitry completely upon the sensing of dry boiling, and the coffee maker stays permanently off.

The secondary reservoir 3 is built adjacent to the primary reservoir 2 and will collect water excessive to the primary reservoir 2 volume. It also builds with the floating block 4 in which the design is, when the water not filled to its maximum, even it is half filled, the floating block 4 cannot activate the switching mechanism 24 thus far the main switch 5 cannot activate the circuitry and start the brewing. This can ensure the primary reservoir 2 is to be used prior to the secondary reservoir 3 whenever the primary reservoir 2 is filled. Underneath the secondary reservoir 3 it is an identical design the manual reset thermostat control 17 will break the circuitry when the reservoir is pumped empty.

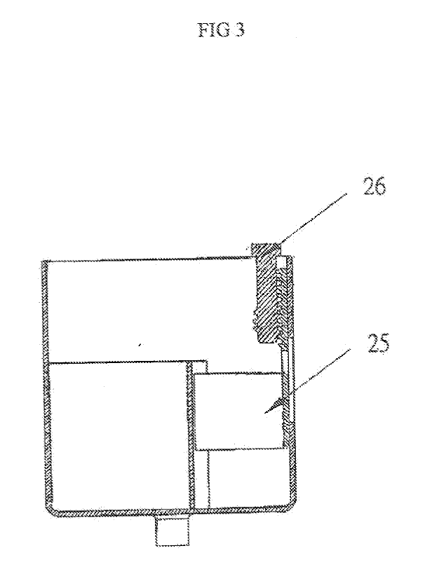

As shown in FIG. 3 the two cups automatic coffee maker with flow control, in between the primary reservoir 2 and secondary reservoir 3 there is a partition that has a cut open at one end to allow the excess water flow from the primary reservoir 2 to the secondary reservoir 3. A sluice-valve 25 sits at the cut open, which has a screw 26 mounted on the top of the reservoirs adjusts its height. When adjusting the height of the sluice-valve 25, the water level of both of the primary reservoir 2 and the secondary reservoir 3 are adjusted at the same time. The excess water of the primary reservoir 2 will drain out to the secondary reservoir 3 through the sluice-valve 25 and consequently the excess water of the secondary reservoir 3 will drain out from the coffee maker also through this sluice-valve 25. The sluice-valve 25 is capable to control the water level inside both the reservoirs means the user can deliberately to control the desired volume of one-cup coffee by the adjustable screw 26 to adjust the height of the sluice-valve 25.

The present invention provide a selection for brewing two cups of coffee at the same time or brewing two cups of coffee in tandem explain as the following details operation description as stated.

When brewing two cups of coffee at the same time, both primary reservoir 2 and secondary reservoir 3 are empty and the floating blocks 4 are sitting at the bottom. When both primary reservoir 2 and secondary reservoir 3 filled with water, both floating blocks 4 rise up and swing their own horizontal linkages 20 so that they both linking up with their own switching mechanism 24 in the separated primary and secondary reservoirs. When the main switch 5 points to the middle shown in 4b for selection of brewing two cups, with the horizontal linkages in place, press down the main switch 5 now able to trigger both manual reset thermal controls 17. Pusher 19 is integrated to the main switch 5 is also used to hold the selection of the sprinkle heads 13. Sprinkle heads 13 now are sitting on top of both the coffee filters 10 when the main switch 5 points to middle, thus allowing the hot water to drain over the 2 independent coffee filters 10 and brew 2 different tastes of coffee. Upon the activation of the manual reset thermal control 17 it short the electric circuit and the heater soldered ducts 14 start to energize, hence the brewing cycle begin until both primary reservoir 2 and secondary reservoir 3 drain empty. When the disc shape bimetal 21 built inside the manual reset thermal control 17 senses the temperature drifted to dry boiling, it triggers and activate the manual reset thermal control 17 to break the electric circuit, thus the brewing cycle completed. Manual reset thermal control 17 at the open circuit stage and floating blocks 4 remain sitting at the bottom while both reservoirs showed empty.

When brewing two cups of coffee in tandem, both primary reservoir 2 and secondary reservoir 3 filled with water and both the floating blocks 4 rise up, consequently the horizontal linkages 20 swing to link up both the switching mechanisms 24. Main switch 5 turns to the left for selecting the left mug shown in 4a or turns to right for selecting the right mug shown in 4c, the pusher 19 will link both the sprinkle heads 13 on top of the left coffee filter 10 (or link both the sprinkle heads 13 on top of the right coffee filter 10 if turns to right). Press down the main switch 5 will only activate the manual reset thermal control 17 underneath the primary reservoir 2 hence starts the brewing cycle for a single cup. As soon as the manual reset thermal control 17 activated, the heater soldered water duct 14 starts to pump the water from the primary reservoir 2 into the left coffee filter 10 until the primary reservoir 2 is empty. As long as the primary reservoir 2 is empty, the floating block 4 drops down to its bottom. The horizontal linkage 20 swings back to initial position. When the disc shape bimetal 21 of the manual reset thermal control 17 detect the temperature drifted due to the dry boiling, it triggers the manual reset thermal control 17 and breaks open the electric circuit, thus stop the brewing cycle. Press the main switch 5 once again with the selection of either left or right mug, the main switch 5 now only have the horizontal linkage 20 of the secondary reservoir 3 underneath, hence it only can activate the manual reset thermal control 17 from the secondary reservoir 3. The heater soldered water duct 14 will start pumping the water from the secondary reservoir 3 into either the left or right coffee filter 10, and brewing the second cycle. As long as the secondary reservoir 3 drains empty and finished the brew, the floating block 4 drops to its bottom, the horizontal linkage 20 swings back to its initial position, and the manual reset thermal control 17 break the electric circuit after detecting the dry boiling temperature.

What is claimed is:

1. A two cup automatic coffee maker with flow control in a precise manner to allow brewing of one or two cups of coffee in a desired volume comprising:
two reservoirs, comprising a primary reservoir and a secondary reservoir, to avoid overfill and able to have different tastes for each cup, wherein each reservoir can be heated separately or in tandem to brew one or two cups respectively; and
a manual reset thermostat control to turn off the heaters when the brewing cycle is completed.

2. The two cups automatic coffee maker with flow control according to claim 1, wherein it comprises:
a main body, primary reservoir, secondary reservoir, floating block, spring loaded main switch, switch mount, switch cover, cancel button, top cover, coffee filters, coffee filter holder, brewing chamber, sprinkle head, heater soldered water ducts, water pipes, drip tray, manual reset thermal control, bottom cover, pusher, horizontal linkage, disc shape bimetal, terminal, spring, switching mechanism, sluice-valve, adjustable screw.

3. The two cups automatic coffee maker with flow control according to claim 1, wherein main body consists of primary reservoir, and secondary reservoir have the same volume identical to the cup with the desired volume, each reservoir is built with a floating block, wherein to provide the indication of the amount of water filled.

4. The two cups automatic coffee maker with flow control according to claim 3, wherein between primary reservoir and secondary reservoir there is a partition which has cut opening and builds with the adjustable sluice-valve for drain out excess water.

5. The two cups automatic coffee maker with flow control according to claim 4, the sluice-valve is capable to control the water level inside both reservoirs and user can control the desired volume of one-cup coffee by adjust the screw on the top of the reservoirs to adjust the height of the sluice-valve.

6. The two cups automatic coffee maker with flow control according to claim 3, wherein primary reservoir builds with a floating block linked to a switch mechanism, thereof when primary reservoir is filled with the water the floating block rises up and embroils a horizontal linkage to the switching mechanism to activate the heater and to start the brewing.

7. The two cups automatic coffee maker with flow control according to claim 1, wherein all water inside the primary reservoir will be drained completely to the coffee filter through pumping system and drips ultimately to the mug underneath the brewing basket for a single cup serving.

8. The two cups automatic coffee maker with flow control according to claim 3, wherein secondary reservoir is built adjacent to the primary reservoir thereof collect the water excessive to the primary reservoir volume, inside the reservoir builds the adjustable sluice-valve to drain away the excessive water to the external water reservoir.

9. The two cups automatic coffee maker with flow control according to claim 3, wherein the secondary reservoir builds with the floating block thereof the design is to control when the water not filled to its maximum, even it is half filled, the floating block cannot activate the switching mechanism thus far the press button cannot activate the circuitry and start the brewing to ensure the primary reservoir is to be used prior to the secondary reservoir whenever the primary reservoir is filled.

10. The two cups automatic coffee maker with flow control according to claim 1, wherein underneath primary reservoir and secondary reservoir build with a manual reset thermostat controls thereof when brewing cycle completed the heater will stay permanently off, as the electric circuitry breaks off mechanically.

11. The two cups automatic coffee maker with flow control according to claim 1, wherein a cancel button which enable to serve as a pause and resume function so that the brewing cycle can be paused and resumed in the mid way of the brewing cycle.

12. The two cups automatic coffee maker with flow control according to claim 1, wherein builds with a one cup or two cups service selection button, thereof the user can choose to use primary reservoir and secondary reservoir at the same time in order to brew two cups coffee through the separated brewing basket therefore it is possible to have two different tastes at the same time and also can brewing two cups coffee in tandem.
